(19) United States
(12) Patent Application Publication
(10) Pub. No.: US 2015/0027574 A1
(43) Pub. Date: Jan. 29, 2015

(54) VALVE FOR FIELD-SENSITIVE LIQUIDS, AND HYDRAULIC SYSTEM HAVING A VALVE OF THIS TYPE

(71) Applicant: Helmut-Schmidt-Universität Hamburg, Hamburg (DE)

(72) Inventors: Rainer Bruns, Hamburg (DE); Stephan Ulrich, Hamburg (DE); Konstantin Krivenkov, Hamburg (DE); Holger Freyer, Altenholz (DE); Jan Isermann, Bremen (DE)

(21) Appl. No.: 14/444,435

(22) Filed: Jul. 28, 2014

(30) Foreign Application Priority Data
Jul. 29, 2013 (EP) 13003759.1

(51) Int. Cl. F16K 31/12; F16K 31/06; F16K 15/00

(52) U.S. Cl. CPC F16K 31/12; F16K 15/00; F16K 31/06
USPC 137/807

(57) ABSTRACT

Disclosed is a valve for field-sensitive liquids having a valve channel and at least one coupling element for coupling a control field into the valve channel. The valve has a control body which can be moved counter to the force of a restoring element in order to change a flow cross section and can be moved by way of the action of the field-sensitive liquid. A hydraulic system comprising the valve is also disclosed.

The invention relates to a valve for field-sensitive liquids having a valve channel and at least one coupling element for coupling a control field into the valve channel. Furthermore, the invention relates to a hydraulic system having a valve of this type.

Actuating valves are usually used in the control of hydraulic systems, in order to control volumetric flows of highly pressurized hydraulic liquid. To this end, conventional actuating valves as a rule have a valve channel, in which a control body can be moved in order to change the flow cross section. Here, the movement of the control body takes place via actuating drives such as servomotors or electromagnetic actuators.

Recently, field-sensitive liquids have been used increasingly in hydraulics. Here, in the context of the invention, field-sensitive liquids are understood to mean liquids, the viscosity of which changes as a result of the action of an electrical or magnetic field. Liquids of this type are also called electrorheological or magnetorheological liquids. Valves which have at least one coupling element for coupling a control field into the valve channel have been developed for field-sensitive liquids of this type. By way of the control field which is coupled in, the viscosity of the field-sensitive liquid can be increased and therefore the flow of the liquid can be throttled.

Unlike in the case of conventional valves, the actuating range in the described valves for field-sensitive liquids is greatly limited, however. For instance, operating pressures of more than 100 bar often have to be switched in modern hydraulic systems. In order for it to be possible to switch a pressure difference of this type by means of a valve of this type, the valve channel would have to be very long, which is often unsuitable technically.

In valves of this type, it is likewise impossible to close the valve channel completely, since a continuous throughflow has to be ensured precisely in the case of electrorheological liquids in order to avoid electric breakdown. This further limits the possible uses of the valves.

The object of the invention therefore consists in providing a valve for field-sensitive liquids, which valve does not have the abovementioned disadvantages.

According to the invention, this object is achieved by way of a valve for field-sensitive liquids having a valve channel and at least one coupling element for coupling a control field into the valve channel, which valve is developed by virtue of the fact that the valve has a control body which can be moved counter to the force of a restoring spring element in order to change the flow cross section and can be moved by way of the action of the field-sensitive liquid. The restoring spring element of the control body can have, for example, a non-linear characteristic, in order to reduce or to completely avoid a non-linearity of the valve behavior.

Here, the invention is based on the finding that the movement of a control body which is known from conventional valve types can be effected not only via complicated actuators, but also by way of direct action of the field-sensitive liquid on the control body. Here, the effect is utilized that a force which is exerted on the control body by the flowing liquid is greatly dependent on the viscosity of the liquid. If this viscosity is changed by way of the utilization of the field-sensitive property of the liquid, the force which is exerted on the control body also changes, as a result of which said control body is displaced with compression or expansion of the restoring spring element. The displacement can be effected by way of a corresponding arrangement of the control body in such a way that said displacement leads to the change of the flow cross section in the valve channel, that is to say, for example, to a constriction or to a widening of the flow cross section.

This effect is comparable to a certain extent with the function of known non-return or pressure relief valves, in which a control body is moved by way of the action of a fluid and therefore opens (pressure relief valve) or closes (non-return valve) the valve. However, the viscosity is not influenced in known valves of this type.

According to one preferred refinement of the invention, at least one coupling element is arranged on the control body. As a result, the field-sensitive liquid can be influenced directly at the control body, which makes particularly rapid response behavior of the valve possible.

In one embodiment of the invention, the movement of the control body is effected by way of the static pressure of the field-sensitive liquid.

In another embodiment of the invention, the movement of the control body is effected by way of the thrust of the field-sensitive liquid. In the context of the invention, the thrust is understood to mean the force which acts on the control body in the flow direction of the liquid and is produced as a result of the friction which occurs between the liquid and the surface of the control body.

In one variant of the invention, the control body is formed as a dividing wall between the valve channel and a pressure chamber which is connected on the pressure side to the valve channel. Here, a pressure difference is produced between the pressure chamber and the valve channel, which pressure difference is dependent on the dynamic pressure loss of the field-sensitive liquid in the valve channel. If the viscosity of the liquid is then increased by coupling of a control field into the valve channel, the dynamic pressure loss and therefore the pressure difference rise, and the control body is pressed in the direction of the valve channel. As a result, the valve channel is constricted, with the result that the flow-reducing action of the control field is reinforced.

In a further variant of the invention, the control body is configured as a wedge which can be moved by way of the static pressure of the field-sensitive liquid along an oblique plane. Here, a thrust which is reinforced if a control field is coupled in and brings about a displacement of the control body along the oblique plane acts between the inflow side and the outflow side of the control body as a result of the pressure difference. The valve channel is once again constricted as a result.

It can be advantageous for regulation or control of the valve function if at least one sensor is provided, in order to measure the position of the control body. Two sensors are preferably provided, in order to determine the position of the control body in the flow direction and transversely with respect to the flow direction. For example, the strength of the control field can be regulated or controlled via the determined position of the control body.

In another design variant, the control body and the valve channel are of conical configuration, and the control body can be moved by way of the action of the field-sensitive liquid in order to change the free flow cross section of the valve channel in the flow direction. In this design variant, a pressure gradient is once again produced over the length of the conical control body, as a result of which said control body is pressed counter to the force of a restoring spring in the flow direction.

It can also be appropriate in this design variant to determine the position of the control body via one or more sensors, in order to make regulation of the valve possible.

According to one development of the invention, the control body can be of conical configuration in the region of the coupling element. In this case, this likewise results in a constriction of the flow channel upon movement of the control body.

According to one development of a different type, the control body can be of conical configuration outside the region of the coupling element. In this case, the spacing of the coupling elements remains unchanged; as a result, the valve behaves in a linear manner and is particularly simple to control or to regulate.

In a further refinement of the invention, the valve channel and the control body have a step-shaped taper which acts as a flow orifice. In the context of the invention, a flow orifice is understood to mean a section of the valve channel which is completely closed when the section of the control body with the greater diameter dips into the section of the valve channel with the smaller diameter.

According to one special development of the invention, a bypass line branches off from the valve channel on the outflow side of the control body. Even in the case of a largely or completely closed valve, said bypass line makes a defined flow of field-sensitive liquid along the coupling element possible. This measure can prevent firstly that a short-circuit of the control field occurs when the liquid is at a standstill. Here, a short-circuit is to be primarily understood to mean an accumulation of particles which are dispersed in the liquid, as a result of which a conductive connection might occur.

The thrust on the control body likewise remains as a result of the flow of the liquid via the bypass line, with the result that permanent closure of the valve can also be effected by way of the thrust.

In one variant of the invention, the valve is configured in such a way that the control body can be moved counter to the force of the restoring spring element in order to constrict the free flow cross section.

In another variant of the invention, the valve is configured in such a way that the control body can be moved counter to the force of the restoring spring element in order to widen the free flow cross section.

In the following text, the invention will be explained in greater detail using some drawings, in which:

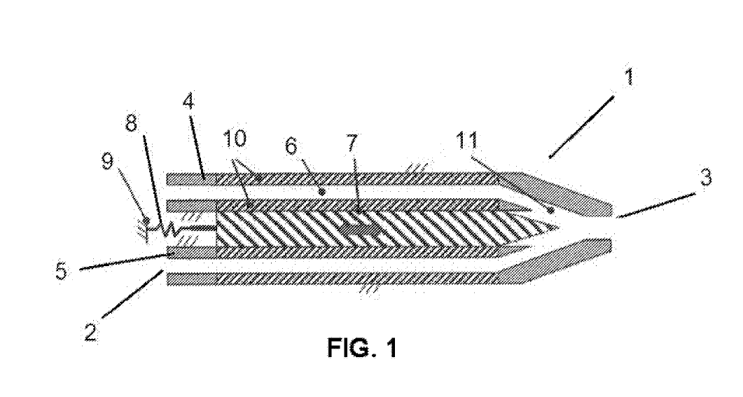

FIG. 1: shows an outline illustration of a first exemplary embodiment of a valve according to the invention,

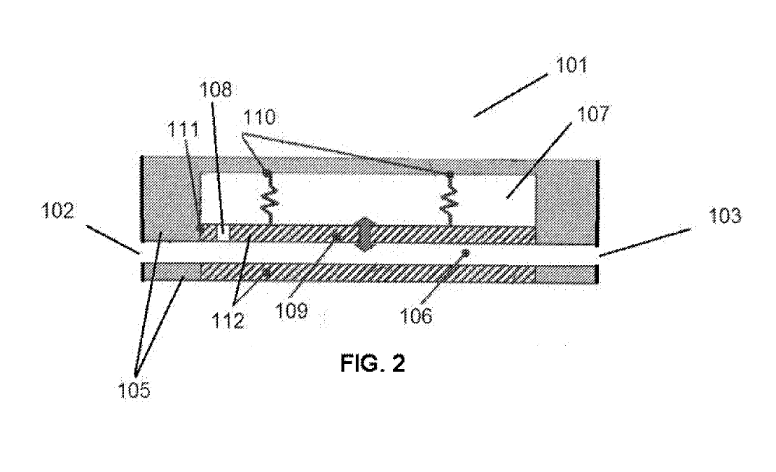

FIG. 2: shows an outline illustration of a second exemplary embodiment of a valve according to the invention,

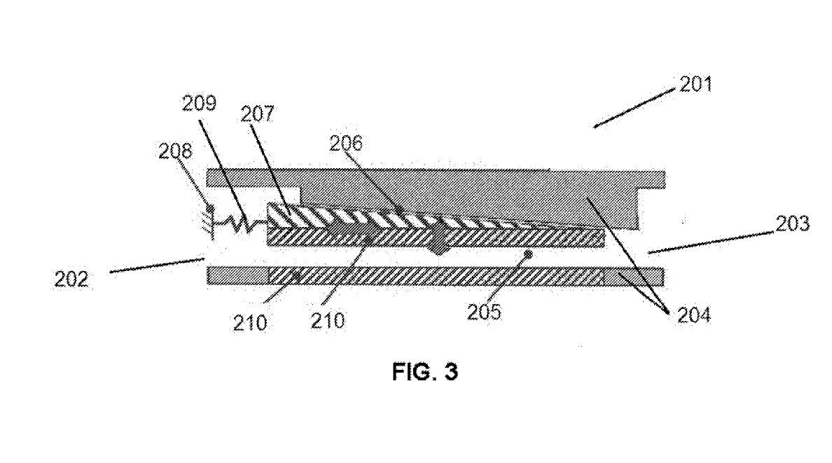

FIG. 3: shows an outline illustration of a third exemplary embodiment of a valve according to the invention,

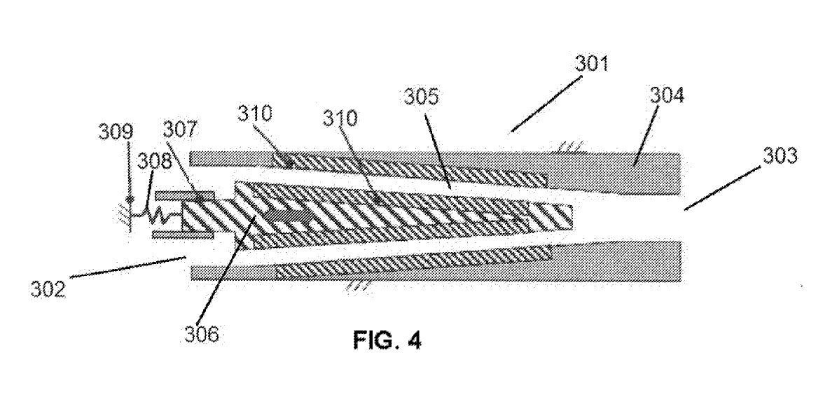

FIG. 4: shows an outline illustration of a fourth exemplary embodiment of a valve according to the invention,

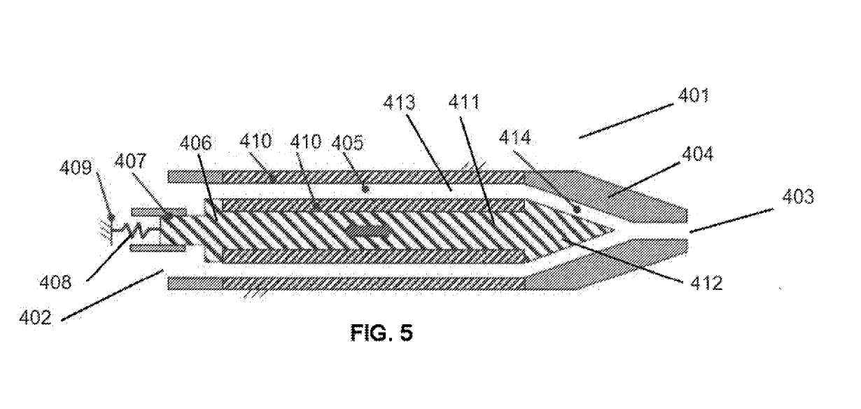

FIG. 5: shows an outline illustration of a fifth exemplary embodiment of a valve according to the invention,

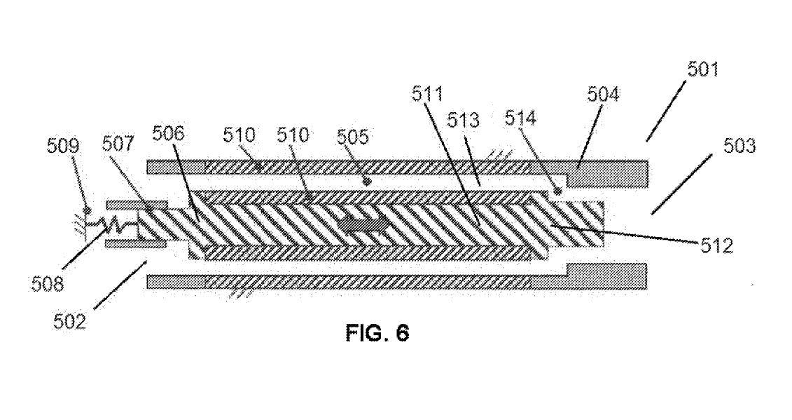

FIG. 6: shows an outline illustration of a sixth exemplary embodiment of a valve according to the invention,

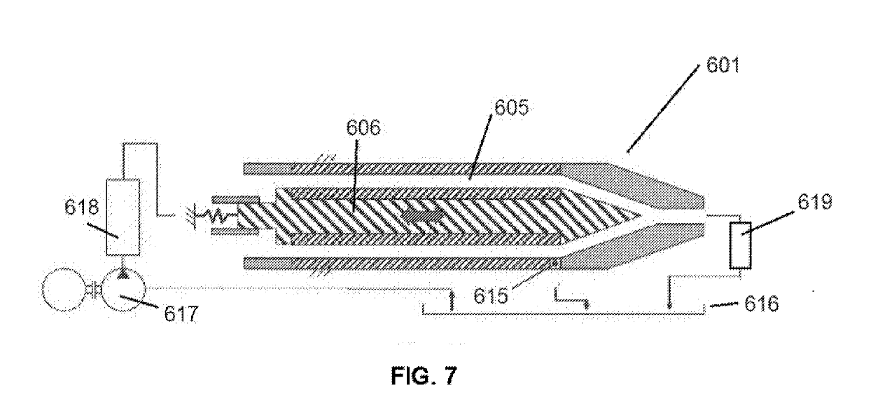

FIG. 7: shows an outline illustration of a hydraulic system having a seventh exemplary embodiment of a valve according to the invention,

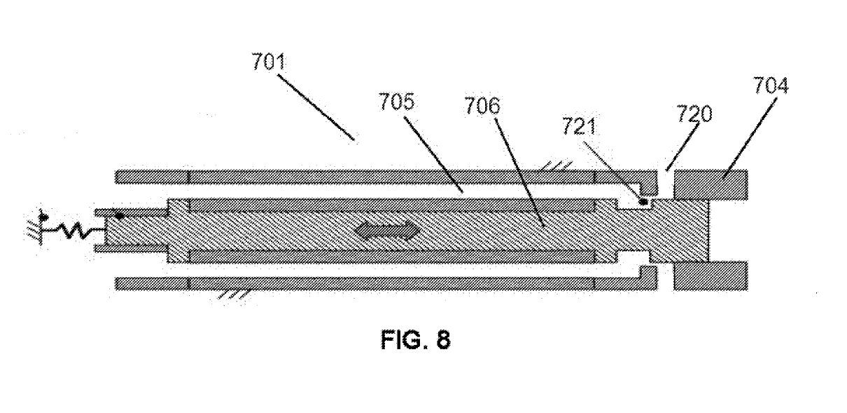

FIG. 8: shows an outline illustration of an eighth exemplary embodiment of a valve according to the invention,

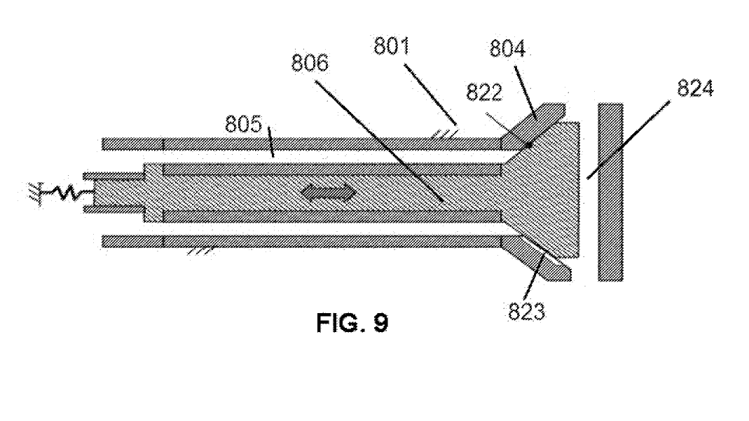

FIG. 9: shows an outline illustration of a ninth exemplary embodiment of a valve according to the invention,

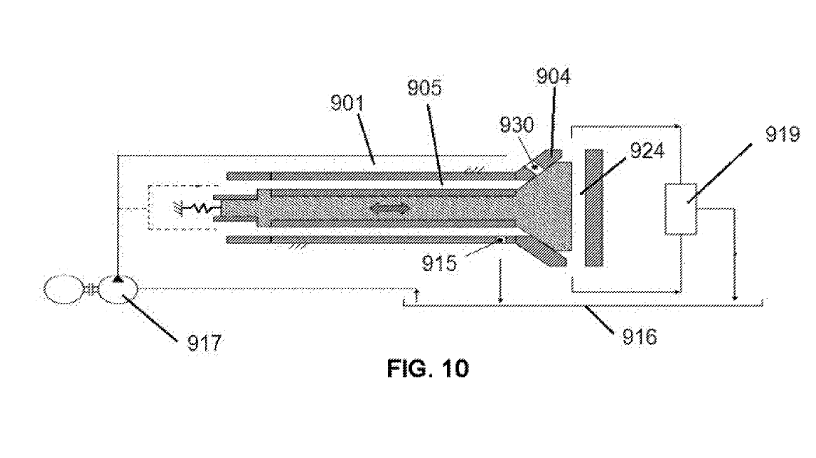

FIG. 10: shows an outline illustration of a hydraulic system having a tenth exemplary embodiment of a valve according to the invention,

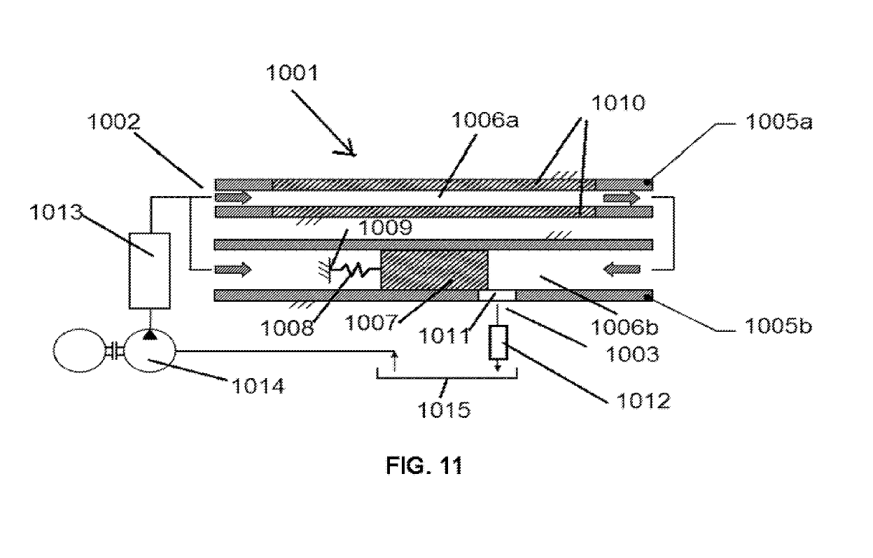

FIG. 11: shows an outline illustration of an eleventh exemplary embodiment of a valve according to the invention, and

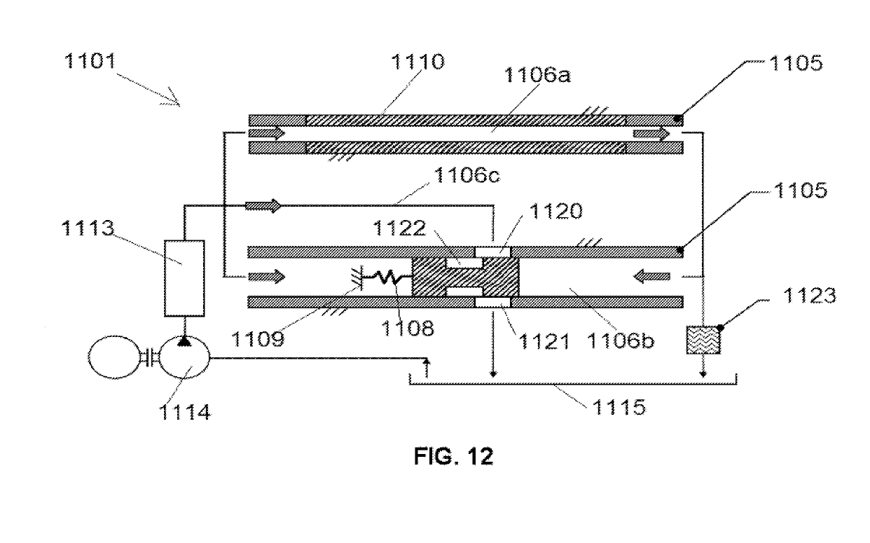

FIG. 12: shows an outline illustration of a twelfth exemplary embodiment of a valve according to the invention.

FIG. 1 shows a valve 1 for field-sensitive liquids having an inflow side 2 and an outflow side 3. The valve has an outer housing 4 and an inner housing 5 which enclose a valve channel 6 between them.

A control body 7 is arranged movably in the inner housing 5. The control body 7 is in contact with the valve channel 6 on the inflow side 2 and the outflow side 3.

During operation of the valve 1, the field-sensitive liquid flows through the valve channel 6. Here, a pressure gradient is produced between the inflow side 2 and the outflow side 3, as a result of which pressure gradient the control body 7 experiences a force in the direction of the outflow side 3. In order to compensate for said force, the control body 7 is fastened to an abutment 9 via a restoring spring 8.

Coupling elements 10 are arranged on the outer housing 4 and on the inner housing 5 of the valve, via which coupling elements 10 a control field can be coupled into the valve channel 6. Said coupling elements 10 can be electrodes if the field-sensitive liquid is an electrorheological liquid. If it is a magnetorheological liquid, the coupling elements 10 are configured as magnet armatures.

In order to switch the valve 1, the coupling elements 10 are activated by suitable activation elements (not shown), in order to generate the control field. As a result of the action of the control field, the viscosity of the field-sensitive liquid is increased, which has the consequence that the pressure gradient rises over the length of the valve channel 6. The force which acts on the control body 7 therefore also rises in the direction of the outflow side 3, with the result that said control body 7 is displaced counter to the force of the restoring spring 8 in the direction of the outflow side 3.

As a result of the displacement of the control body 7, the valve channel 6 is constricted in its conical end region 11. As a result of this additional constriction of the valve channel 6, the effect of the control field which makes a flow of the field-sensitive liquid more difficult is reinforced, with the result that the actuating range of the valve 1 is increased considerably in comparison with conventional valves for field-sensitive liquids, and relatively great pressure differences can also be switched in valve channels 6 of relatively short design.

FIG. 2 shows another embodiment of the invention. The valve 101 once again has an inflow side 102 and an outflow side 103 and consists of a housing 105 which encloses a valve channel 106. A pressure chamber 107 is provided in the housing 105, which pressure chamber 107 is connected via an aperture 108 to the valve channel 106. A control body 109 which acts as a dividing wall is arranged between the valve channel 106 and the pressure chamber 107.

During operation of the valve 101, a field-sensitive liquid flows through the valve channel 106. Here, a pressure gradient is produced over the length of the valve channel 106. Here, the pressure which prevails on the inflow side 102 of the valve 101 also prevails in the pressure chamber 107, with the result that a lower pressure prevails on the outflow side 103 in the valve channel 106 than in the pressure chamber 107. As a result, a force acts on the control body 109 in the direction of the valve channel 106, which force is compensated for by way of restoring springs 110 during normal operation.

At the edge 111 of the control body, said control body is sealed with respect to the housing 105 by means of seals (not shown). They can be, for example, bellows seals or sliding seals.

Coupling elements 112 are arranged on the control body 109 and at a point of the housing 105, which point lies opposite the control body 109, via which coupling elements 112 a control field can be coupled into the valve channel 106. If the viscosity of the field-sensitive liquid is increased by way of said control field, the pressure difference between the valve channel 106 and the pressure chamber 107 rises. The resulting force on the control body 109 becomes greater than the force of the restoring springs 110, with the result that the control body 109 is pressed into the valve channel 106 and constricts the latter further. As a result, the action of the control field is reinforced and the actuating range of the valve 101 is widened.

In the above-described exemplary embodiments of the invention, the movement of the control bodies 7, 109 is effected solely or predominantly by way of the static pressure of the field-sensitive liquid. FIGS. 3 to 7 show exemplary embodiments, in which the movement of the respective control bodies is also or exclusively brought about by way of dynamic thrusts of the field-sensitive liquid.

The valve 201 which is shown in FIG. 3 once again has an inflow side 202, an outflow side 203 and a housing 204 which encloses a valve channel 205. On one side of the valve channel 205, the housing 204 has an oblique plane 206, against which a control body 207 bears slidingly.

During operation of the valve 201, a field-sensitive liquid flows through the valve channel 205. By way of friction on the control body 207, the liquid exerts a thrust on the control body 207, which thrust acts in the flow direction and is absorbed via a restoring spring 209 which is fastened to an abutment 208.

Coupling elements 210 are arranged on the control body 207 and at a point of the housing 204, which point lies opposite the control body 207 on the valve channel 205.

If a control field is coupled into the valve channel 205 via the coupling elements 210, the viscosity of the field-sensitive liquid rises. As a result, the thrust which is produced by way of friction on the control body 207 also rises, with the result that said control body 207 is moved with deflection of the restoring spring 209 in the flow direction of the liquid. Here, the control body 207 is pressed via the oblique plane 206 into the valve channel 205, with the result that the latter is constricted. Here too, the available actuating range of the valve 201 is increased considerably by way of the constriction of the valve channel 205 with a simultaneous increase in the viscosity of the field-sensitive liquid.

FIG. 4 shows a further design variant of a valve according to the invention. The valve 301 likewise has an inflow side 302, an outflow side 303 and a housing 304. A valve channel 305 which tapers conically in the flow direction is formed within the housing 304, in which valve channel 305 a control body 306 is arranged movably which likewise tapers conically in the flow direction. On the inflow side, the control body 306 is mounted slidingly in a sleeve 307. The control body 306 is fastened to an abutment 309 via a restoring spring 308.

During operation, the field-sensitive liquid flows along the control body 306 through the valve channel 305 and in the process exerts a thrust which acts in the direction of the outflow side 303. At the same time, a pressure gradient is produced along the valve channel, which pressure gradient brings about an additional force on the control body 306. The forces which act on the control body 306 during normal operation of the valve 301 are absorbed by the restoring spring 308.

Coupling elements 310 are arranged on the inner side of the valve channel 305 and on the outer side of the control body 306, via which coupling elements 310 a control field can be generated in the valve channel 305. As a result, the viscosity of the liquid is increased and both the pressure gradient along the valve channel 305 and the thrust rise. As a consequence, the control body 306 is moved counter to the force of the restoring spring 308 in the direction of the outflow side 303. As a result, the valve channel 305 is constricted and the action of the control field is therefore reinforced further.

FIG. 5 shows a further variant of a valve 401 according to the invention which coincides in large parts with the variant which is shown in FIG. 4. Coinciding elements are therefore provided merely with a reference numeral which is increased by 100 and will not be explained in further detail.

In the exemplary embodiments of the valve according to the invention which are shown in FIGS. 2 to 4, the movement of the respective control bodies is also accompanied by a change in the spacing between the coupling elements which lie opposite one another. Since firstly a force acts between the coupling elements when the control field is coupled in, which inhibits or assists the movement of the control body depending on the orientation of the control field, and secondly a change in the spacing between the coupling elements causes a reinforcement or lowering of the control field, the actuating behavior of the valves which are shown is greatly non-linear.

It is therefore advantageous to monitor the position of the control body, the pressure of the liquid at various points in the valve and/or the flowing speed of the liquid by means of sensors (not shown) and to regulate the behavior of the valve via this. For example, adaptive regulating methods are recommended to this end on account of the complex non-linear relationships.

In contrast to the variant which is shown in FIG. 4, the control body 406 in the variant of the valve 401 which is shown in FIG. 5 now has a cylindrical section 411 and a conical section 412. Correspondingly, the valve channel 405 runs cylindrically in a first section 413 and conically in a second section 414. Here, the coupling elements 410 are situated only in the cylindrical section of the control body 406 and in the cylindrical section of the housing 404.

The spacing in the radial direction between the coupling elements 410 during the movement of the control body 406 does not change as a result of this design, but rather the valve channel 405 is merely constricted in the conical section 414 when the control body is displaced in the flow direction of the field-sensitive liquid. Since the spacing of the coupling elements 410 remains constant in this variant, the response behavior of the valve is easier to regulate. The use of one or more sensors is of course also appropriate in this and all further variants which are shown, in order to regulate the actuating behavior of the valve.

FIG. 6 shows a further variant of a valve according to the invention which corresponds substantially to the variant which is shown in FIG. 5. Elements of the variant in FIG. 6 which are identical to elements of the variant which is shown in FIG. 5 are merely provided with a reference numeral which is increased by 100 and will not be described in further detail.

The embodiment of FIG. 6 differs from the embodiment of FIG. 5 in that the valve channel 505 has, on the outflow side, a section 514 which runs in a stepped manner and is formed by way of corresponding steps in the housing 504 and in the outlet-side end 512 of the control body 506. If the control body 506 moves in the flow direction of the field-sensitive liquid, the free flow cross section is changed in the manner of an orifice plate. Here, the housing 504 and the control body 506 are dimensioned in such a way that the greater external diameter of the control body 506 fits with little play into the smaller internal diameter of the housing 504 and can therefore completely close the valve channel 505 at its outflow-side end 514.

FIG. 7 shows a hydraulic system with a valve according to one development of the embodiment which is shown in FIG. 5. Elements which correspond to one another will therefore not be described again in the following text.

In the embodiment which is shown, the valve channel 605 is connected via a bypass line 615 to a collecting container 616. The outflow side of the valve channel 605 passes to a consumer 619 and is likewise fed to the collecting container 616 after leaving the consumer 619. The collecting container is connected to a pump 617 which feeds the field-sensitive liquid to a reservoir 618 in a pressure-loaded manner. After flowing through the reservoir 618, the liquid flows through the valve 601, by way of which the pressure in the consumer 619 can be controlled.

Depending on the properties of the consumer, said consumer can also be arranged at the position 618. In this case, 619 is a hydraulic line or hydraulic resistance.

The bypass line 615 then allows the valve 601 to close completely, with the result that no more liquid passes to the consumer 619. At the same time, however, a continuous flow of the liquid through the valve channel 605 is still ensured, in order to avoid a short-circuit in the liquid. In addition, the thrust on the control body 606 is maintained by way of said flow, in order to hold the valve 601 closed reliably.

A corresponding bypass line can of course also be provided with the same action and with the same advantages in all other exemplary embodiments.

The exemplary embodiments which have been described up to now are all configured so as to close actively, with the result that the valve is in each case open in the case of a non-activated control field. For defined applications, in which a valve is in each case to be opened only briefly, it can be advantageous to provide a valve which opens actively.

FIG. 8 shows an actively opening exemplary embodiment of a valve 701 according to the invention. The basic construction of the valve 701 corresponds here substantially to the above-described exemplary embodiments, with the result that a repeated description is dispensed with. The valve channel 705 is configured on the outlet side as an aperture 720 which leads laterally out of the valve housing 704. The outlet-side end of the control body 706 closes the main branch of the valve channel 705.

In the region in front of the aperture 720, the valve channel 705 is constricted to such an extent that only a narrow passage remains between the housing 704 and the control body 706, through which narrow passage a small but continuous flow of the field-sensitive liquid can flow through the valve 701. If a control field is then generated in the valve channel 705, the thrust which acts on the control body 706 also rises on account of the increased viscosity of the field-sensitive liquid, as a result of which the control body is deflected in the direction of the outflow side. Here, a groove 721 which is arranged in the control body 706 passes into the region of the constriction of the housing 704 and of the valve channel 705, with the result that the free flow cross section in the region of the groove 721 is enlarged and the field-sensitive liquid can flow into the aperture 720 with a reduced flow resistance. The valve 701 is therefore open. Here, the cross-sectional enlargement should over-compensate for the viscosity which is increased by way of the applied control field.

FIG. 9 shows a modification of the valve which is shown in FIG. 8, the housing 804 and the control body 806 of the valve 801 having conical sealing faces 822 on the outflow side. Here, a bypass channel 823 is provided in one of the sealing faces 822, through which bypass channel 823 once again a continuous flow of the field-sensitive liquid can flow into an outflow-side channel 824.

If a control field is coupled into the valve channel 805, an increased thrust is once again exerted on the control body 806, with the result that the latter is moved in the flow direction of the field-sensitive liquid. As a result, the sealing faces 822 of the housing 804 and the control body 806 move away from one another, the free flow cross section is increased and the valve is opened. Here, the cross-sectional enlargement should over-compensate for the increased viscosity as a consequence of the control field.

The valves which are shown in FIGS. 8 and 9 cannot close completely because of the operating principle. At the same time, it is necessary in order to open said valves that a control field is coupled into the valve channel, as a result of which the maximum liquid flow which can be achieved is limited.

FIG. 10 shows a hydraulic system with a further variant of an actively opening valve, which variant is improved further in this regard.

The hydraulic system consists of a valve 901 which is of similar construction to the above-described valves. Unlike in the above-described exemplary embodiments, the valve channel 905 here is connected to a collecting container 916 via a control bypass 915. Here too, a continuous flow of the field-sensitive liquid flows through the valve channel 905, but said continuous flow does not pass into the outflow-side channel 924, with the result that the valve 901 is completely closed in the rest state.

If a control field is coupled into the valve channel 905, the thrust on the control body 906 rises, as has already been described with respect to the preceding exemplary embodiments, and said control body 906 is moved in the flow direction. As a result, the valve 901 is opened.

In order to further increase the stream of the field-sensitive liquid which flows through the open valve 901, a useful bypass 930 is provided in the outflow-side region of the housing 904. The useful bypass 930 is connected directly to a pump 917 which conveys the field-sensitive liquid through the hydraulic system. In this way, in the case of an open valve 901, a useful flow of the liquid passes without impairment by way of the control field from the pump 917 through the useful bypass 930 into the outflow-side channel 924 and then to the consumer 919. After flowing through the consumer 919, the useful flow of the liquid also passes into the collecting container 916 and, from there, is introduced again into the hydraulic system via the pump 917.

FIG. 11 shows a further exemplary embodiment of the invention with a valve 1001 of multiple-stage configuration with an inflow side 1002 and an outflow side 1003. The valve 1001 has a housing comprising two parts 1005a, 1005b which enclose a two-part valve channel 1006a, 1006b. Once again, coupling elements 1010 are arranged on the first housing part 1005a of the housing, via which coupling elements 1010 a control field can be coupled into the valve channel 1006a of the valve 1001. A control body 1007 is arranged in the second part 1006b of the valve channel, which control body 1007 is articulated via a spring element 1008 on an abutment 1009. The control body 1007 partially covers an outflow opening 1011 of the valve 1001.

During operation, the field-sensitive liquid is conveyed from a collecting container 1015 by way of a pump 1014 into a reservoir 1013. From the reservoir 1013, the field-sensitive liquid flows through the valve channel 1006a, 1006b and presses here on the end face of the control body 1007, which end face is loaded by restoring force or spring force. At the same time, the field-sensitive liquid is guided to a remote side of the control body 1007 in the section 1006b of the valve channel. If a control field is then coupled via the coupling elements 1010 into the section 1006a of the valve channel, the viscosity of the field-sensitive liquid is increased as a result, so that a pressure drop is produced over the section 1006a of the valve channel. The pressure on the spring force-loaded side of the control body becomes higher. On the remote side of the control body 1007, in contrast, the pressure remains constant. A pressure difference is therefore produced over the control body 1007, which pressure difference moves said control body 1007 counter to the restoring force or spring force and in the direction counter to the spring element, as a result of which closing of the outflow opening 1011 is effected.

As a result of the multiple-stage configuration of the valve 1001, said valve 1001 is capable of acting over an actuating range which is increased considerably in comparison with single-stage configurations.

FIG. 12 shows a modification of the valve which is shown in FIG. 11. The valve 1101 once again has an inflow side 1102 and an outflow side 1103 and a valve channel 1106a, 1106b, 1106c which connects them and is in this case in three parts. The valve 1101 has a housing 1105 which consists of a plurality of parts. The useful flow of a field-sensitive liquid is guided through the part 1106c of the valve channel through cross-flow openings 1120, 1121 through the part 1106b of the valve channel. In said part 1106b of the valve channel, a control body 1107 is arranged which partially closes the cross-flow openings 1120, 1121. The control body 1107 has a circumferential groove 1122 which produces a connection between the cross-flow openings 1120, 1121. The control body 1107 is fastened to an abutment 1109 via a spring 1108, as in the other embodiments of the valve.

During operation, the field-sensitive liquid is conveyed from collecting container 1115 by way of a pump 1114 into a pressure-loaded reservoir 1113. From said reservoir 1113, part of the field-sensitive liquid flows as control flow through the part 1106a of the valve channel, on which coupling elements 1110 for coupling in a control field are arranged, and then flows back into the collecting container 1115 through an additional resistance 1123. The additional resistance 1123 can be, for example, a tubular section with a defined flow resistance.

Upstream of the additional resistance 1123, the second part 1106b of the valve channel branches off, which second part 1106b is closed by the control body 1107. On the other side of the part 1106b of the valve channel, the latter is connected to the reservoir 1113. The pressure which prevails in the reservoir 1113 therefore acts from one side on the control body 1107, and only the pressure which prevails over the additional resistance 1123 acts from the other side.

As long as the flow resistance of the additional resistance 1123 is considerably greater than that of the part 1106a of the valve channel, practically no force acts on the control body 1107, and the latter lies in its rest position. If the resistance in the part 1106a of the flow channel is now increased by a control field being coupled in, the pressure which prevails over the additional resistance 1123 drops, and the control body 1107 is deflected counter to the force of the spring 1108 by way of the pressure difference which results. As a result, the free cross section of the connection between the cross-flow openings 1120, 1121 changes, and the flow of the field-sensitive liquid through the part 1106c of the valve channel is therefore controlled.

By way of a corresponding selection of the rest position of the control body 1107, the valve 1101 can be configured to be either actively opening or actively closing, a control behavior of the valve 1101 which is linear over a wide range being achieved by way of the separation of the useful flow from the control flow.

1. A valve for field-sensitive liquids having a valve channel and at least one coupling element for coupling a control field into the valve channel, wherein the valve has a control body which can be moved counter to the force of a restoring element in order to change a flow cross section and can be moved by way of the action of the field-sensitive liquid.

2. The valve according to claim 1, wherein at least one coupling element is arranged on the control body.

3. The valve according to claim 1, wherein the movement of the control body is effected by way of the static pressure of the field-sensitive liquid.

4. The valve according to claim 2, wherein the movement of the control body is effected by way of the thrust of the field-sensitive fluid.

5. The valve according to claim 3, wherein the control body is formed as a dividing wall between the valve channel and a pressure chamber which is connected on the pressure side to the valve channel.

6. The valve according to claim 3, wherein the control body is configured as a wedge which can be moved by way of the action of the field-sensitive liquid along an oblique plane.

7. The valve according to claim 3, wherein the control body and the valve channel are of conical configuration, and in that the control body can be moved by way of the action of the field-sensitive liquid in order to change the free flow cross section of the valve channel in the flow direction.

8. The valve according to claim 7, wherein the control body is of conical configuration in the region of the coupling element.

9. The valve according to claim 7, wherein the control body is of conical configuration outside the region of the coupling element.

10. The valve according to claim 3, wherein the valve channel and the control body have a step-shaped taper which acts as a flow orifice.

11. The valve according to claim 1, wherein a bypass line branches off from the valve channel on an outflow side of the control body.

12. The valve according to claim 1, wherein the control body can be moved counter to the force of the restoring element in order to constrict the free flow cross section.

13. The valve according to claim 1, wherein the control body can be moved counter to the force of the restoring element in order to widen the free flow cross section.

14. A hydraulic system comprising a valve according to claim 1.

15. The hydraulic system according to claim 14, wherein a control hydraulic flow and a useful hydraulic flow are configured so as to be separate from one another, and the valve is arranged parallel to the useful hydraulic flow.
